(19) United States
(12) Patent Application Publication
(10) Pub. No.: US 2026/0220284 A1
(43) Pub. Date: Jul. 30, 2026

(54) TRUSTED APPLICATION PROTOCOL-BASED COMMUNICATION

(71) Applicant: CRUNCHFISH DIGITAL CASH AB, Malmo (SE)

(72) Inventors: Paul CRONHOLM, Malmo (SE); Joachim SAMUELSSON, Helsingborg (SE)

(21) Appl. No.: 19/150,233

(22) PCT Filed: Feb. 7, 2024
(86) PCT No.: PCT/IB2024/051131

§ 371 Date: Jul. 23, 2025

(30) Foreign Application Priority Data
Feb. 7, 2023 (SE) 2350116-6
Feb. 13, 2023 (SE) 2350135-6
Feb. 21, 2023 (SE) 2350200-8
Mar. 29, 2023 (SE) 2350364-2

(51) Int. Cl. G06F 21/60; H04L 9/08; H04L 9/30; H04L 9/32

(52) U.S. Cl. CPC G06F 21/606; H04L 9/0825; H04L 9/30; H04L 9/3247; H04L 9/3265

(57) ABSTRACT

The claimed invention concerns a method (100) for building trust in communication application. The invention solves the problem of current methods requiring an exchange of cryptographic information in a handshake procedure. The problem is solved by an extension to a layered communication stack for the purpose of introducing trust at the application layer from a sending device. The added trusted application protocol layer provides trust to services regardless of the communication network and is implemented by running a trusted application (102) that keeps a private cryptographic key in a secure execution environment and keeping a digital certificate in the sending communication device, the digital certificate comprising a public cryptographic key corresponding to the private cryptographic key being signed by a certificate authority, wherein a second application in the sending device receives signed data and signature and generates (120) a header or tail with the signature and certificate and sends (130) this information to a receiving

### TECHNICAL FIELD

The present invention generally relates to the field of data communication. More specifically, the present invention relates to a communication method for providing trust at a receiving side, and associated communication devices and computer readable medium/computer program product.

### BACKGROUND

Digital applications of today are typically designed using a client server network architecture. Although reliant on the very robust internet protocol, access to the digital service is nevertheless uncertain, as the user may not be able to get online access.

Digital applications in general are not as robust as should be given their critical role as public or commercial goods in a modern society. As they are typically implemented using a client-server network model, the digital service is only available if the user gets online network access over the internet.

To obtain trust in communication with such digital applications, existing approaches like IPsec (IP Security) and Secure Shell (SSH) require exchange of cryptographic information in a handshake procedure between the parties of the communication. This comes with expenses, not only because preparatory steps will have to be made at both communication clients and in view of the amount of handshake communication necessary, but also because of the inherent reliance on a stable online internet access.

The present inventors have realized that there is room for improvements in this field.

### SUMMARY

In line with the observations above, the present inventors have made valuable technical insights to solve or at least mitigate one or more of the challenges referred to in the previous section. These insights will be presented as inventive aspects in the following description and the drawings. The list of inventive aspects is not to be seen as exhaustive but rather a summary of particularly beneficial inventive aspects.

In a nutshell, the present inventors have invented technical solutions which are directed at an extension to a layered communication stack for the purpose of introducing trust at the application layer. Unlike the aforementioned existing approaches (e.g. IPsec or SSH), the present invention does not require exchange of cryptographic information in a handshake procedure between the parties of the communication. On the contrary, with the present invention, no such preparatory provisions are required at the receiver side.

The extension is not limited to any particular existing communication stack and is application agnostic. The extension can, for instance, be applied as an extra layer above or next to the application layer in the Open Systems Interconnection (OSI) model, or any model based on the Transmission Control Protocol (TCP) and/or the User Datagram Protocol (UDP) and/or the Internet Protocol (IP), without limitation.

The present disclosure seeks to provide robustness for any digital application by the provision of a trusted client. Adding an application agnostic trusted application protocol layer to digital applications will have a profound impact on client-server applications as it provides trust to the service regardless of the communication network, e.g. TCP/IP, SS7 over telecom or using any local network or proximity bearer.

The Trusted Application Protocol, TAP, is a protocol that can be used by any applications, across any platform and on any communication network, i.e. TAP is extremely generic and completely agnostic to the underlying application, platform, operating system or communication network.

Having a trusted client is very useful for any digital application that requires login, executing a single command or automatic login without a passphrase to a remote server. This could for instance be used by electronic identification applications.

Any application becomes more robust by the trusted application as it is possible to use alternative routes than the internet to connect to the remote server with end2end integrity. Even in circumstances where the internet is available, TAP adds additional integrity for the application data and ties the user directly to the trusted client, which is beneficial for invoicing in subscription-based applications. TAP may also be used for having a trusted identity on social media platform to get improved accountability for what is posted online.

TAP is arguably the most important improvement in digital communications since the internet was introduced in the 90s. Whereas the internet TCP/IP protocol made digital communications more robust, it is of little use if the application cannot get online access. The TAP protocol provides robustness as well as trust to digital applications by providing alternative routes to the remote server. The usefulness of a robust internet as such can be questioned if a user cannot get online access to the digital service.

In consideration of the above, a first aspect of the invention is a communication method involving:
in a sending communication device:
   running a trusted application that keeps a private cryptographic key in a secure execution environment,
   keeping a digital certificate in the sending communication device, the digital certificate comprising a public cryptographic key corresponding to the private cryptographic key and being signed by a certificate authority;
   running a second application, outside of the secure execution environment;
   the second application making a signing request to the trusted application, the signing request including application data;
   the trusted application acting upon the signing request by signing the application data, or a data set comprising the application data, with the private cryptographic key to create a signature, and providing the signature to the second application;
   the second application causing generation of a trusted application protocol header or tail comprising the signature as provided from the trusted application and the digital certificate, inclusion of the generated trusted application protocol header or tail as well as the application data, or the data set comprising the application data, as payload in a data packet being compliant with an application layer of a communication stack, and sending of the data packet; and
in a receiving communication device:
   receiving the data packet;
   retrieving the signature and the digital certificate from the trusted application protocol header or tail in the payload of the received data packet; and
   verifying the authenticity of the application data in the payload of the received data packet by applying the public cryptographic key of the digital certificate to the application data, or to the data set comprising the application data, and comparing with the signature.

A second aspect of the invention is a communication device configured to perform the functionality of the sending communication device in the communication method according to the first aspect of the invention.

A third aspect of the invention is a communication device configured to perform the functionality of the receiving communication device in the communication method according to the first aspect of the invention.

A fourth aspect of the invention is a non-volatile computer readable medium having stored thereon a computer program comprising computer program code for performing the functionality of the sending communication device in the communication method according to the first aspect of the invention when the computer program code is executed by a processing device.

A fifth aspect of the invention is a non-volatile computer readable medium having stored thereon a computer program comprising computer program code for performing the functionality of the receiving communication device in the communication method according to the first aspect of the invention when the computer program code is executed by a processing device.

As used in this document, the term “wide area network communication” (abbreviated as “WAN communication”) includes any form of data network communication with a party which may be remote (e.g. cloud-based), including cellular radio communication like W-CDMA, GSM, UTRAN, HSPA, LTE, LTE Advanced or 5G, possibly communicated as TCP/IP traffic, or via a WLAN (WiFi) access point, without limitation. Moreover, the terms “long-range data communication” and “broadband data communication” are considered as synonyms of “wide-area network communication”.

Expressions like “[entity] is configured for . . . [performing activity]” or “[entity] is configured to . . . [perform activity]” will include typical cases where a computerized entity (having one or more controllers, processing units, programmable circuitry, etc.) executes software or firmware installed in the computerized entity, wherein the execution occurs in order to perform the activity in question. It should be emphasized that the term “comprises/comprising” when used in this specification is taken to specify the presence of stated features, integers, steps, or components, but does not preclude the presence or addition of one or more other features, integers, steps, components, or groups thereof. Generally, all terms used herein are to be interpreted according to their ordinary meaning in the technical field, unless explicitly defined otherwise herein. All references to “a/an/the [element, device, component, means, step, etc.]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The following detailed description of the invention will be based upon the attached drawings. In the drawings:

FIG. 1 is a schematic illustration of a communication method according to an embodiment of the present invention, using TAP to provide trust of a sending communication device for a receiving communication device.

FIG. 2 is a schematic illustration of preparatory steps at the sending communication device to enable it for TAP communication.

FIG. 3 is a schematic illustration of an example of a communication stack extended with a TAP layer.

FIG. 4 is illustrates the possibility of bidirectional TAP communication.

FIG. 5 is a schematic illustration of a first example of a TAP packet structure.

FIG. 6 is a schematic illustration of a second example of a TAP packet structure.

FIG. 7 is a schematic block diagram of a communication device that may implement a sending communication device or a receiving communication device in a communication method as described in this document.

FIG. 8 is a schematic illustration of a non-volatile computer-readable medium in one exemplary embodiment, capable of storing a computer program product.

### DETAILED DESCRIPTION

Embodiments of the invention will now be described with reference to the accompanying drawings. The invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular embodiments illustrated in the accompanying drawings is not intended to be limiting of the invention. In the drawings, like numbers refer to like elements.

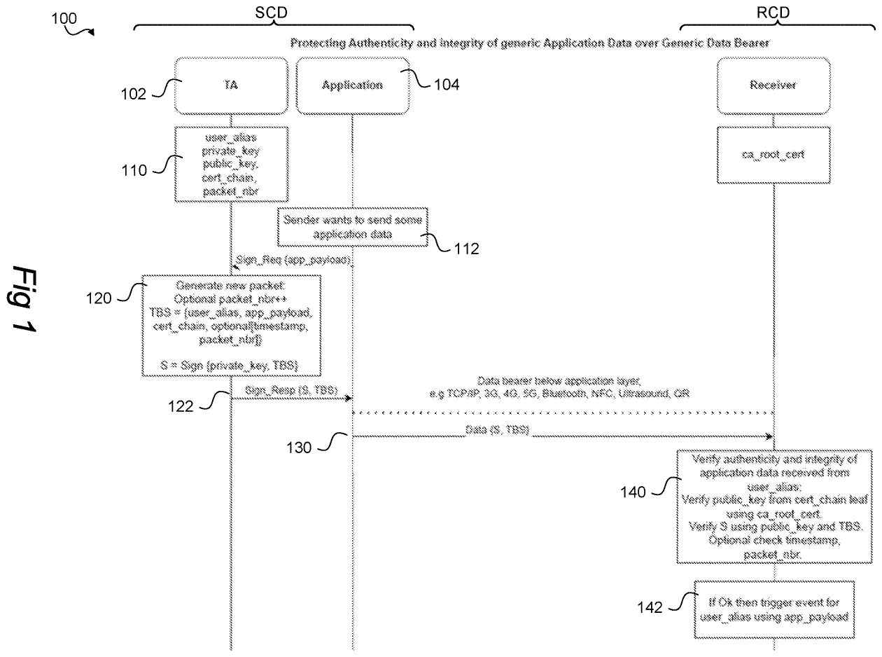

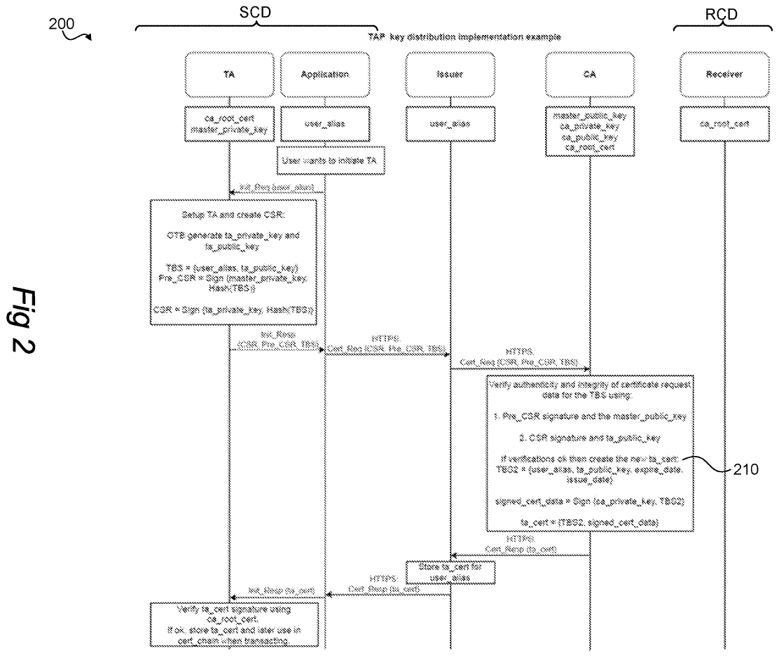

Reference is first made to FIG. 1 that illustrates an embodiment of a communication method 100, using TAP to provide trust of a sending communication device SCD for a receiving communication device RCD. Differently put, FIG. 1 illustrates how the authenticity and integrity of generic application data communicated over a generic data bearer (carrier) can be protected. Reference is also made to FIG. 2 which explains some preparatory steps 200 having been performed at a previous moment at the sending communication device SCD to enable it for TAP communication. Note that no preparations are required for the receiving communication device RCD.

As can be seen in FIG. 1, the communication method 100 involves the following in the sending communication device SCD:

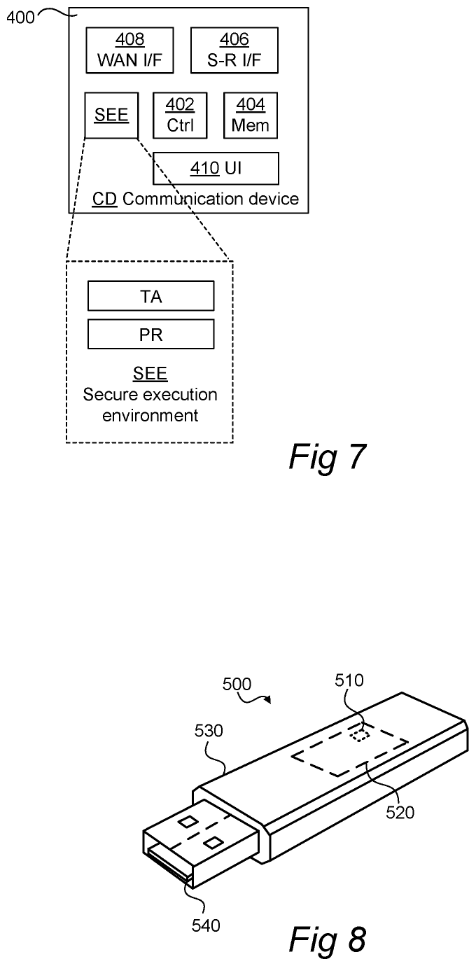

Running a trusted application TA that keeps a private cryptographic key private key (referred to as ta_private_key in FIG. 2) in a secure execution environment (cf. SEE, FIG. 7). See 102 and 110 in FIG. 1.

Keeping a digital certificate as part of a certificate chain cert_chain (including digital certificate ta_cert as previously generated at 210 in FIG. 2) in the sending communication device SCD. See 110 in FIG. 1. The digital certificate comprises a public cryptographic key public key (referred to as ta public key in FIG. 2) that corresponds to the private cryptographic key private key (FIG. 2: ta_private_key) and has been signed by a certificate authority CA, preferably an independent certificate authority (as seen in FIG. 2).

Running a second application, outside of the secure execution environment. The second application is referred to as Application in FIGS. 1 and 2. See 104 in FIG. 1.

The second application making a signing request Sign_Req to the trusted application TA. The signing request includes application data app_payload. See 112 in FIG. 1.

The trusted application TA acting upon the signing request by signing the application data app_payload, or a data set TBS that comprises the application data, with the private cryptographic key private_key (ta_private_key) to create a signature S. See 120 in FIG. 1. The trusted application TA provides the signature S to the second application (Application). See 122 in FIG. 1.

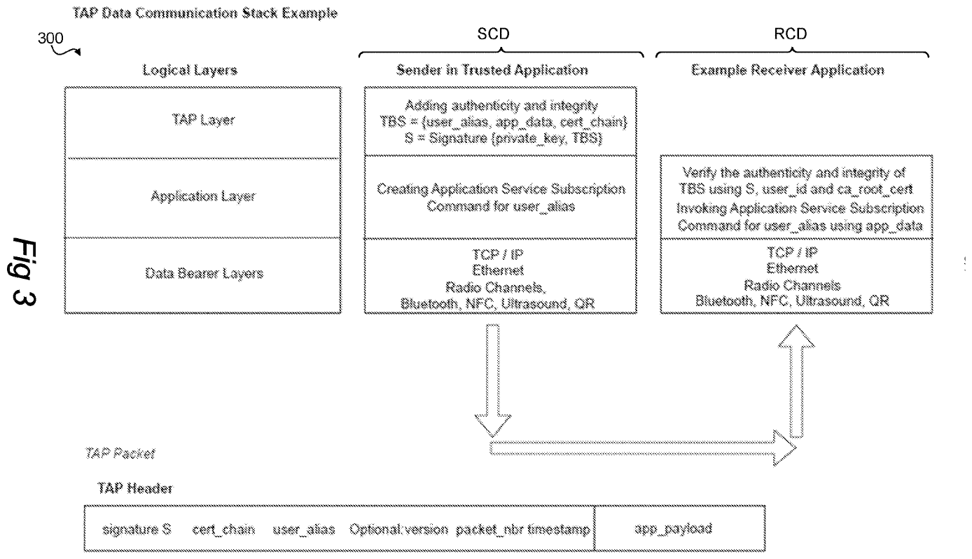

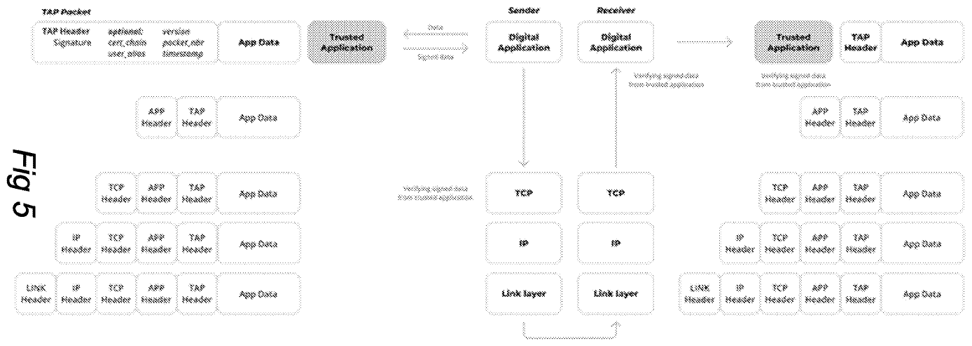

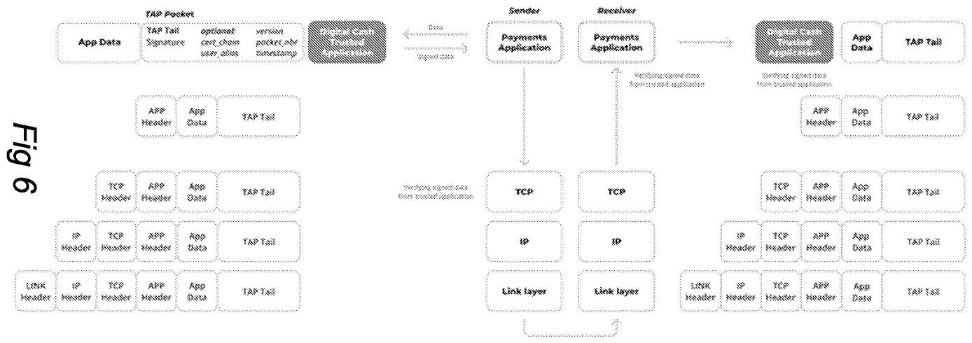

As seen at 130 in FIG. 1, the second application (Application) then causes:
Generation of a trusted application protocol header or tail comprising the signature S as provided from the trusted application TA and the digital certificate cert_chain; ta_cert. A trusted application protocol header is seen as TAP Header in FIGS. 3 and 5. A trusted application protocol tail is seen as TAP Tail in FIG. 6.
Inclusion of the generated trusted application protocol header or tail as well as the application data app_payload, or the data set TBS comprising the application data, as payload in a data packet that is compliant with an application layer of a communication stack.
Sending of the data packet.
   The communication method 100 of FIG. 1 then involves the following in the receiving communication device RCD, as seen at 140 in FIG. 1:

Receiving the data packet.

Retrieving the signature S and the digital certificate cert_chain; ta_cert from the trusted application protocol header or tail in the payload of the received data packet.

Verifying the authenticity of the application data in the payload of the received data packet by applying the public cryptographic key public_key (ta_public_key) of the digital certificate to the application data app_payload, or to the data set TBS comprising the application data, and comparing with the signature S.

Once verified, the receiving communication device RCD may take appropriate action, now been assured of trust. Such action may involve triggering some event for a user (identified by user_alias) of the sending communication device SCD based on the application data app_payload. This can be seen at 142 in FIG. 1.

Albeit not seen in FIG. 1, the receiving communication device RCD typically runs a third application at the application layer of the communication stack in a normal execution environment, i.e. not a secure execution environment. The steps of retrieving the signature S and the digital certificate cert_chain; ta_cert from the trusted application protocol header or tail in the payload of the received data packet and verifying the authenticity of the application data app_payload in the payload of the received data packet are performed by the third application.

This communication method introduces trust to the receiving communication device RCD, since it will be able to verify that the contents of the data packet (i.e., the application data app_payload) have not been manipulated by any intermediate device or network node during the communication of the data packet from the sending communication device SCD to the receiving communication device RCD-notably without requiring any prior exchange of cryptographic information in a handshake procedure between these two parties of the communication.

Since the trusted application protocol header or tail is included together with the application data, or the data set comprising the application data, in a data packet which is compliant with an application layer of a communication stack, no changes will have to be made to the underlying layers of an existing communication stack. This is a huge advantage in terms of compatibility. Reference is made to FIG. 3 that illustrates an example of a communication stack 300 extended with a TAP layer in this manner. In the example of FIG. 3, a trusted application protocol header TAP Header is used. However, beneficially a trusted application protocol tail TAP Tail is used instead, as is shown in FIG. 6.

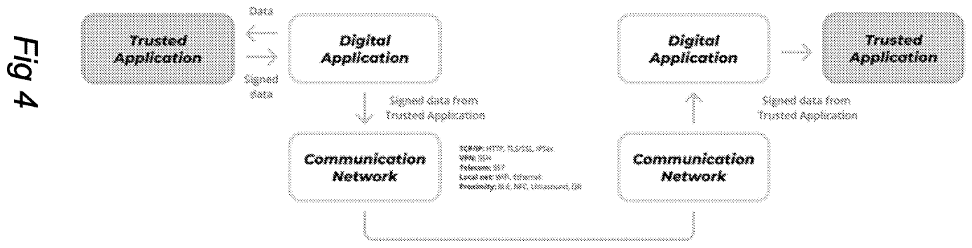

FIG. 4 illustrates the possibility of bidirectional TAP communication, i.e. a case where also the receiving communication device is configured for TAP-based communication (and, thus, in effect will act as a sending communication device). Such capability is however not a mandatory requirement on the invention in its broadest sense.

Beneficially, the communication method introduces trust to the receiving communication device regardless of how the data packet is communicated between the sending communication device and the receiving communication device, i.e. whether it occurs over TCP/IP, SS7 over telecom (3G, 4G, 5G), local area network communication (e.g. Wifi) or a proximity link (short-range data communication). See 130 in FIG. 1 for some examples.

Beneficially, as can be understood from FIG. 6, the trusted application protocol tail (here referred to as TAP Tail) and the application data (here referred to as App Data) may both be communicated in what the underlying communication layers perceive as the payload part of the data packet; hence the introduction of the trusted application protocol will require no adaptation whatsoever of the underlying communication layers (e.g. TCP, IP, Link).

Also, any fourth application run by the receiving communication device RCD or another receiving communication device at the application layer of the communication stack in a normal execution environment, i.e. not a secure execution environment, will be able to receive the data packet and retrieve the application data app_payload from the payload of the data packet even if not configured to act upon the trusted application protocol tail included in the payload. Hence, backward compatibility problems may be avoided or at least mitigated (at the expense of losing the trust-adding functionality provided by the invention).

Alternatively, as can be understood from FIG. 5, the trusted application protocol header (here referred to as TAP Header) and the application data (here referred to as App Data) may both be communicated in what the underlying communication layers perceive as the payload part of the data packet.

In advantageous embodiments, the data packet communicated between the sending communication device SCD and the receiving communication device RCD may be part of an electronic identification procedure. In some embodiments, the data packet communicated between the sending communication device SCD and the receiving communication device RCD may be part of one factor of a two-factor electronic identification procedure.

It is to be noted that the reference to “Digital Cash Trusted Application” and “Payments Application” in FIG. 6 are mere examples. There are no particular limitations on the kind of applications, communications or services performable using the present invention.

In some embodiments, the sending communication device SCD is an end-user device such as a mobile communication device, a mobile phone, a smart phone, a tablet computer, a personal digital assistant, a portable computer, a personal computer, a workstation, smart glasses, a smart wearable, a smart watch, a smart bracelet, a smart card or a smart chip. In other embodiments, the sending communication device SCD is a host device or host function executed in a server computer or a cloud-based computing environment. Correspondingly, the receiving communication device RCD is an end-user device like, for instance, any of the examples referred to above, in some embodiments and a host device or host function executed in a server computer or a cloud-based computing environment in other embodiments. The invention is thus applicable to any situation involving communication between a sending end-user device and a receiving host device/host function, between a sending end-user device and a receiving end-user device (i.e., and end2end or peer-to-peer scenario), or between a sending host device/host function and a receiving end-user device.

Different aspects of the present disclosure include the aforementioned communication method 100, a sending communication device SCD configured to perform the functionality of the sending communication device in the aforementioned communication method, a receiving communication device RCD configured to perform the functionality of the receiving communication device in the aforementioned communication method, a communication system comprising a sending communication device and a receiving communication device according to the above, as well as computer program products and tangible computer-readable media comprising computer program code that upon execution by a processing device will perform the functionality of the sending communication device and of the receiving communication device, respectively.

Reference is now made to FIG. 7 and a communication device CD which is illustrated at 400. The communication device CD may implement any of the sending or receiving communication devices in the communication method as described with reference to the preceding FIGS. 1-6. To this end, the communication device CD comprises a processing device 402, local storage including a memory 404, a short-range data communication interface 406, a wide area network communication interface 408 and a user interface 410.

The processing device 402 acts as a controller of the communication device 400 and may be implemented in any known controller technology, including but not limited to microcontroller, processor (e.g. PLC, CPU, DSP), FPGA, ASIC or any other suitable digital and/or analog circuitry capable of performing the intended functionality.

The memory 404 may be implemented in any known memory technology, including but not limited to ROM, RAM, SRAM, DRAM, CMOS, FLASH, DDR, SDRAM or some other memory technology. In some embodiments, the memory or parts thereof may be integrated with or internal to the processing device 402. The memory may store program instructions for execution by the processing device 402 (also see the description of FIG. 8 below), as well as temporary and permanent data for use by the processing device 402)

The short-range data communication interface 406 may be configured for Bluetooth communication, or any other radio-based short-range wireless data communication such as, for instance, Bluetooth Low Energy, RFID, WLAN, WiFi, mesh communication or LTE Direct, without limitation, or any non-radio-based short-range wireless data communication such as, for instance, magnetic communication (such as NFC), (ultra)sound communication, or optical communication (such as IrDA) without limitation. In some embodiments, the short-range data communication interface 406 comprises equipment and functionality for presenting or scanning a QR code.

The wide area network communication interface 408 may be configured for wide area network communication compliant with, for instance, one or more of W-CDMA, GSM, UTRAN, HSPA, LTE, LTE Advanced or 5G, and TCP/IP, and/or WLAN (WiFi), without limitation.

The user interface 410 may comprise an input device and a presentation device, as is generally known per se. In some embodiments, the input device and the presentation device are constituted by one common physical device, such as for instance a touch screen (touch-sensitive display screen), implemented in for instance resistive touch technology, surface capacitive technology, projected capacitive technology, surface acoustic wave technology or infrared technology.

The communication device CD further comprises a secure execution environment SEE (a.k.a. trusted execution environment or secure element), i.e. a tamper-resistant virtual or hardware-based platform. In the former case, the secure execution environment may have its own CPU and protected memory. In the latter case, the secure execution environment may be implemented in software and may reside in the local storage or even the memory 404.

Advantageously, some of the data and functionality in embodiments of the invention may be stored in and performed by the secure execution environment SEE, as will be clear from other sections of this document, including the drawings. The secure execution environment SEE is capable of securely hosting applications, including the aforementioned trusted application TA, as well as securely storing protected resources PR, including confidential and cryptographic data like the aforementioned private keys. The secure execution environment SEE therefore provides a trusted environment for execution of such applications, a.k.a. secure runtime.

Non-limiting examples of secure execution environment technology known in the art include Samsung TEEGRIS, Qualcomm TEE, Huawei iTrustee, Trustonic Kinibi, Google Open Source Trusty, Open Portable TEE, Nvidia's Trusted Little Kernel for Tegra, Sierra TEE, ProvenCore TEE, Trusty TEE for Android, or TrustKernel T6. Protected hardware resources may be protected by any hardware support technologies known in the art, including but not limited to Arm's TrustZone, MultiZone Security, AMD Platform Security Processor, Intel Software Guard Extensions, Apple's Secure Enclave Processor, and Google's Titan M.

FIG. 8 is a schematic illustration of a computer-readable medium 500 in one exemplary embodiment, capable of storing a computer program product 510. The computer-readable medium 500 in the disclosed embodiment is a portable memory device, such as a Universal Serial Bus, USB, stick. The computer-readable medium 500 may however be embodied in various other ways instead, as is well known per se to the skilled person. The portable memory device 500 comprises a housing 530 having an interface, such as a connector 540, and a memory chip 520. In the disclosed embodiment, the memory chip 520 is a flash memory, i.e. a non-volatile data storage that can be electrically erased and re-programmed. The memory chip 520 stores the computer program product 510 which is programmed with computer program code (instructions) that when loaded into a processing device, such as a CPU, will perform any of the functionalities listed in the next paragraph. The processing device may, for instance, be the aforementioned processing device 402 and/or of any of the types of technology exemplified above for the processing device 402. The portable memory device 500 is arranged to be connected to and read by a reading device for loading the instructions into the processing device. It should be noted that a computer-readable medium can also be other media such as compact discs, digital video discs, hard drives or other memory technologies commonly used. The computer program code (instructions) can also be downloaded from the computer-readable medium via a wireless interface to be loaded into the processing device.

In one embodiment, therefore, the computer program product 510 comprises computer code for performing the functionality of the sending communication device SCD or the receiving communication device RCD in the communication method 100 as described herein when the computer program code is executed by the processing device. Hence, FIG. 7 can be considered to illustrate a non-volatile computer readable medium 500 having stored thereon a computer program (i.e. a computer program product 510) comprising computer program code for performing the aforementioned functionality of the sending communication device or the receiving communication device.

The invention has been described above in detail with reference to embodiments thereof. However, as is readily understood by those skilled in the art, other embodiments are equally possible within the scope of the present invention, as defined by the appended claims.

1. A communication method involving:
in a sending communication device
running a trusted application that keeps a private cryptographic key in a secure execution environment,
keeping a digital certificate in the sending communication device, the digital certificate comprising a public cryptographic key corresponding to the private cryptographic key and being signed by an independent certificate authority
running a second application, outside of the secure execution environment;
the second application making a signing request to the trusted application, the signing request including application data;
the trusted application acting upon the signing request by signing the application data, or a data set comprising the application data, with the private cryptographic key to create a signature, and providing the signature to the second application;
the second application causing:
generation of a trusted application protocol header or tail comprising the signature as provided from the trusted application and the digital certificate inclusion of the generated trusted application protocol header or tail as well as the application data or the data set comprising the application data, as payload in a data packet being compliant with an application layer of a communication stack, and
sending of the data packet; and
in a receiving communication device
receiving the data packet;
retrieving the signature and the digital certificate from the trusted application protocol header or tail in the payload of the received data packet; and
verifying the authenticity of the application data in the payload of the received data packet by applying the public cryptographic key of the digital certificate to the application data, or to the data set comprising the application data, and comparing with the signature.

2. The communication method according to claim 1, wherein the communication method requires no prior exchange of cryptographic information in a handshake procedure between the sending communication device and the receiving communication device.

3. The communication method (100) according to claim 1, wherein the communication method introduces trust to the receiving communication device by allowing it to verify that the contents of the received data packet have not been manipulated by any intermediate device or network node during the communication of the data packet from the sending communication device to the receiving communication device.

4. The communication method according to claim 1, wherein the receiving communication device runs a third application at the application layer of said communication stack in a normal execution environment, i.e. not a secure execution environment, and wherein the steps of retrieving the signature and the digital certificate from the trusted application protocol header or tail in the payload of the received data packet and verifying the authenticity of the application data in the payload of the received data packet are performed by the third application.

5. The communication method according to claim 1, wherein the second application generates said trusted application protocol tail comprising the signature as provided from the trusted application and the digital certificate and includes the generated trusted application protocol tail after said application data, or after said data set comprising said application data, hence requiring no adaptation of underlying communication layers of said communication stack, since said underlying communication layers will perceive said application data, or the data set comprising said application data, as well as the trusted application protocol tail as the payload part of the data packet at the application layer of said communication stack.

6. The communication method according to claim 4,
wherein the receiving communication device runs a third application at the application layer of said communication stack in a normal execution environment, i.e. not a secure execution environment, and wherein the steps of retrieving the signature and the digital certificate from the trusted application protocol header or tail in the payload of the received data packet and verifying the authenticity of the application data in the payload of the received data packet are performed by the third application, and
wherein a fourth application run by said receiving communication device or another receiving communication device at the application layer of said communication stack in a normal execution environment, i.e. not a secure execution environment, will be able to receive said data packet and retrieve said application data from the payload of the data packet even if not configured to act upon the trusted application protocol tail included in said payload.

7. The communication method according to claim 1, wherein said data packet is communicated between said sending communication device and said receiving communication device as part of an electronic identification procedure.

8. The communication method according to claim 1, wherein said data packet is communicated between said sending communication device and said receiving communication device as part of one factor of a two-factor electronic identification procedure.

9. The communication method according to claim 1, wherein said sending communication device is an end-user device, a host device or a host function executed in a server computer or cloud-based computing environment, and wherein said receiving communication device is an end-user device, a host device or a host function executed in a server computer or cloud-based computing environment.

10. A communication device configured to perform the functionality of the sending communication device in the communication method according to claim 1.

11. The communication device according to claim 10, being an end-user device selected from the group consisting of: a mobile communication device, a mobile phone, a smart phone, a tablet computer, a personal digital assistant, a portable computer, a personal computer, a workstation, smart glasses, a smart wearable, a smart watch, a smart bracelet, a smart card, and a smart chip.

12. A communication device configured to perform the functionality of the receiving communication device in the communication method according to claim 1.

13. The communication device according to claim 12, being an end-user device selected from the group consisting of: a mobile communication device, a mobile phone, a smart phone, a tablet computer, a personal digital assistant, a portable computer, a personal computer, a workstation, smart glasses, a smart wearable, a smart watch, a smart bracelet, a smart card, and a smart chip.

14. A non-volatile computer readable medium having stored thereon a computer program comprising computer program code for performing the functionality of the sending communication device in the communication method according to claim 1 when the computer program code is executed by a processing device.

15. A non-volatile computer readable medium having stored thereon a computer program comprising computer program code for performing the functionality of the receiving communication device in the communication method according to claim 1 when the computer program code is executed by a processing device.

16. The communication method according to claim 4, wherein the communication method requires no prior exchange of cryptographic information in a handshake procedure between the sending communication device and the receiving communication device.

17. The communication method according to claim 16, wherein the communication method introduces trust to the receiving communication device by allowing it to verify that the contents of the received data packet have not been manipulated by any intermediate device or network node during the communication of the data packet from the sending communication device to the receiving communication device.

18. The communication method according to claim 5, wherein the communication method requires no prior exchange of cryptographic information in a handshake procedure between the sending communication device and the receiving communication device.

19. The communication method according to claim 18, wherein the communication method introduces trust to the receiving communication device by allowing it to verify that the contents of the received data packet have not been manipulated by any intermediate device or network node during the communication of the data packet from the sending communication device to the receiving communication device.
